(19) United States
(12) Patent Application Publication
(10) Pub. No.: US 2005/0231037 A1
(43) Pub. Date: Oct. 20, 2005

(54) Combination electrical lock device and method for activating the same

(76) Inventors: Jian-Choug Doong, Taipei (TW); Jin-In Chen, Taipei (TW)

Correspondence Address: DELLETT AND WALTERS, P. O. BOX 2786, PORTLAND, OR, 97208-2786, US

(21) Appl. No.: 10/828,368

(22) Filed: Apr. 19, 2004

(51) Int. Cl. B60L 3/00

(52) U.S. Cl. 307/10.1

(57) ABSTRACT

A combination electrical lock is operated in association with a control server disposed near the electrical lock. When a remote user sends a signal to the control server through a wireless device, such as a cellular phone, the control server generates an activating signal to activate the electrical lock, wherein such an activating signal may be in the form of a static magnetic field, a light signal, a sound signal etc. Because the lock device only consumes power when the remote signal is received, accordingly unnecessary electricity consumption is effectively mitigated in the rest of time.

### BACKGROUND OF THE INVENTION

1. Field of the Invention

The present invention relates to a combination electrical lock device and method for activating the same, and more particularly to an electrical lock device that is able to economize electricity consumption due to the long stand-by time operation.

2. Description of Related Art

With the rapid developments in electrical technology, a variety of types of electrical security instruments have become widely used recently. For example, a lock device is the most basic and well known security instrument. With the evolution from the mechanical type into the present electrical type, the lock device offers many beneficial functions in life. Such an electrical lock device may be operated in a remote-controlled mode through a wireless communication or the wired network so that a remote person can control the entry and exit authorization where the lock device is installed.

In the use of the electrical lock device, the failure of the power supply is a particular problem. Several power supply manners including the dry battery-based type, solar battery-based type, mechanical force-based type or the power line connected type are commonly adopted in the electrical lock device. In the dry battery-based type, solar battery-based type and mechanical force-based type popular in the market, electricity consumption only occurs when a user activates the lock device so that the power is efficiently saved. However, these electricity supplying means are accordingly unable to be retained in the power-activated stand-by mode for a long time to wait for a remote control command. If the lock device is intended to be operated under the remote-controlled mode through the network, the lock device must be further connected with signal wires.

Moreover, if the foregoing power-line electricity supply is adopted, the lock device is connected with a power line through which the lock device can derive sufficient electricity (AC power) so that it can always be in the stand-by mode for receiving the remote control signal. The power-line is usually arranged on the doorframe. However, such a wire arrangement is unsuitable in some situations, for example, it is inconvenient to arrange the power line on a main gate composed of a pair of doors. To overcome the foregoing problems, the present invention provides a novel combination electrical lock device to mitigate the problems.

### SUMMARY OF THE INVENTION

The main objective of the present invention is to provide a combination electrical lock device and method for activating the same, wherein without any connection of a power line to the electrical lock device, the lock device is activated according to a remote signal. The lock device only consumes power when the remote signal is received, and accordingly the unnecessary electricity consumption is effectively mitigated.

To accomplish the objective, the combination electrical lock device is composed of an electrical lock and a control server, wherein the control server comprises:
a server control circuit, which controls all elements in the control server;
an activating signal transmitting circuit connected to the server control circuit, which outputs an activating signal to activate the electrical lock;
an AC power supply circuit connected to the server control circuit to supply an operating voltage for the control server; and
an electromagnetic signal transceiver connected to the server control circuit to receive a remote control signal;
wherein the electrical lock comprises:
a main control circuit, which controls all elements in the electrical lock device;
an activating signal receiving circuit connected to the main control circuit to receive the activating signal; and
a power supply circuit connected to the main control circuit to provide an operating voltage for the electrical lock;
wherein when the electrical lock receives the activating signal from the control server, the power of the electrical lock is thus being activated.

Other features of the invention will become apparent from the detailed description when taken in conjunction with the attached drawings.

### BRIEF DESCRIPTION OF THE DRAWINGS

FIG. 1 is a block diagram showing a combination electrical lock device according to a first embodiment of the present invention;

FIG. 2 is an operational view showing the present invention; and

FIG. 3 is a block diagram showing a combination electrical lock device according to a second embodiment of the present invention.

### DETAILED DESCRIPTION OF THE PREFERRED EMBODIMENT

The present invention provides a combination electrical lock device and a method for activating the lock device, wherein dry batteries or solar energy or other types without physical connection of power lines is applied as the power supply.

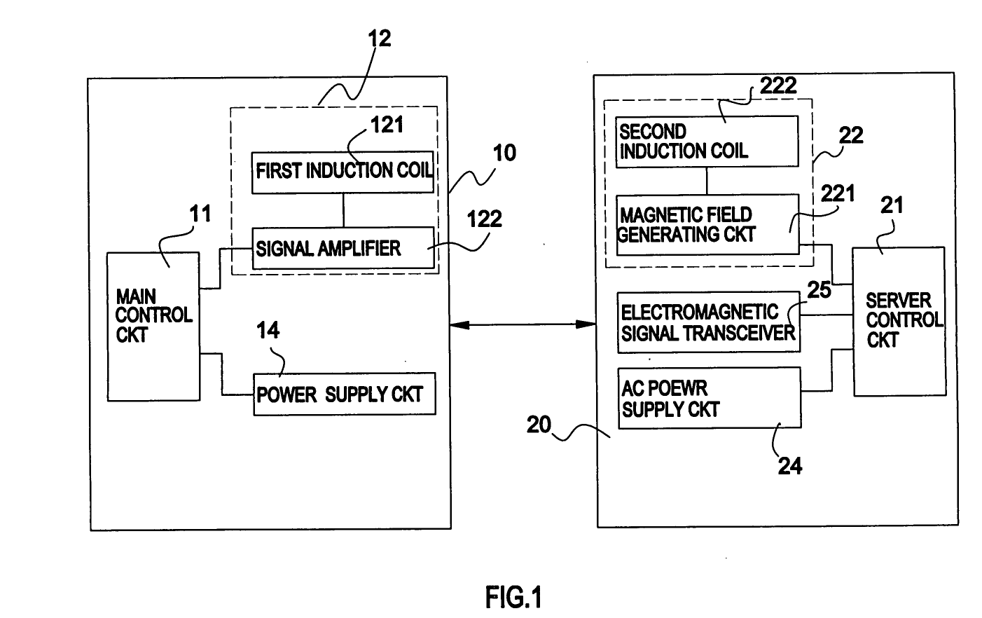

With reference to FIG. 1, the present invention is composed of an electrical lock device (10) and a control server (20) that generates a signal (hereinafter activating signal) to activate the lock device (10). The lock device (10) according to a first embodiment includes a main control circuit (11), an activating signal receiving circuit (12) and a power supply circuit (14).

The main control circuit (11) controls the operation of all elements in the lock device (10). In the first embodiment, the activating signal receiving circuit (12) is consisted of an induction coil (121) and a signal amplifier (122). An output terminal of the first induction coil (121) is connected to the main control circuit (11) through the signal amplifier (122), wherein the first induction coil (121) is provided to receive said activating signal.

The power supply circuit (14), connected to the main control circuit (11), provides operating electricity for the lock device (10), wherein the power supply circuit (14) can be conventional dry batteries or a solar energy circuit.

In another aspect, said control server (20) of the first embodiment has a server control circuit (21), an activating signal transmitting circuit (22), an electromagnetic signal transceiver (25) and an AC power supply circuit (24).

The server control circuit (21) controls the operation of all elements in the server (20). The activating signal transmitting circuit (22) is formed by a magnetic field generating circuit (221) and a second induction coil (222). The magnetic field generating circuit (221) is connected between the server control circuit (21) and the second induction coil (222). The AC power supply circuit (24) connects to the server control circuit (21) to provide operating voltage to elements of the server (20). The electromagnetic signal transceiver (25) is connected to the server control circuit (21) to receive a remote control signal from a user. The remote control signal, for example, could be an electromagnetic signal emitted from a cellular phone or a remote controller.

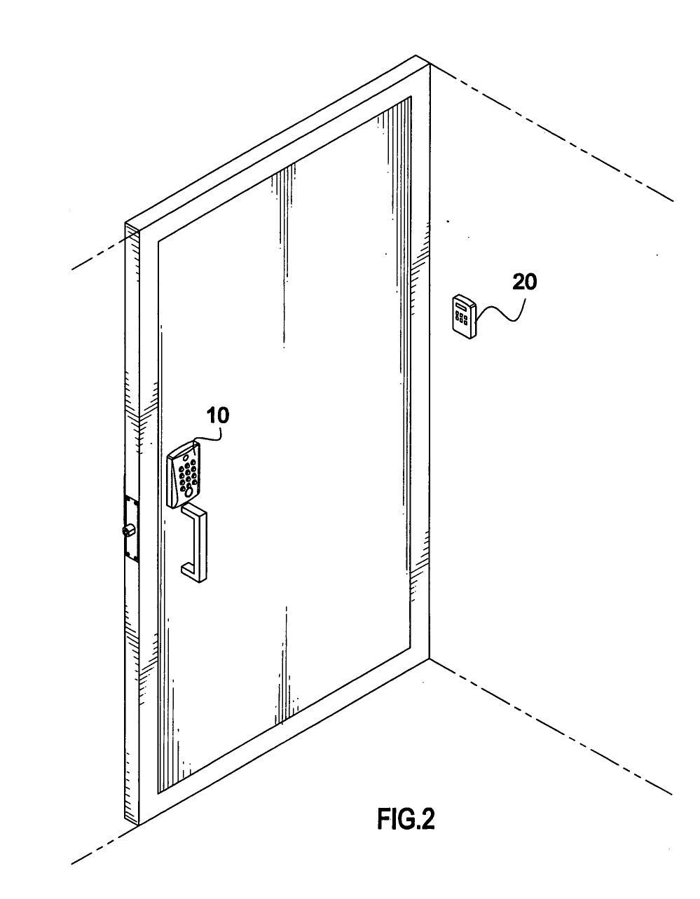

With reference to FIG. 2, when in use, the electrical lock device (10) is mounted on a doorframe as usual and the control server (20) is installed at any desired place near the lock device (10) within an effective inducting range. Mostly, AC power source or switches can be found near the entrance. Based on such a condition, the AC power supply circuit (24) is connected to the AC power source to acquire the operating voltage thus being the stand-by mode. In other words, the control server (20) derives sufficient electricity at any time so that any unexpected remote control activation from the user could be successfully received.

When the remote control signal is received by the electromagnetic signal transceiver (25), the server control circuit (21) outputs a command to activate the magnetic field generating circuit (22). The magnetic field generating circuit (221) further drives the second induction coil (222) to continuously output a static magnetic field.

When the first induction coil (121) of the lock device (10) detects the existence of the static magnetic field, an inducted signal passes through the signal amplifier (122) to the main control circuit (11). Based on the amplified signal, the main control signal (11) wakes the power supply circuit (14) up thus activating the lock device (10) to execute default operations. Once the default operations are done, the lock device (10) automatically shuts down itself and waits for the next activation.

In the aspect of the lock device (10), the electricity supply is deemed as a wireless manner, i.e. without the use of a power line and signal wire. Most of the time, the lock device (10) is in a power-economizing mode and is only activated when the control server (20) issues the activating signal. In the aspect of the control server (20), since sufficient power is supplied to the control server (20), the server (20) can satisfy the requirement of the remote control mode.

In the first embodiment, the interaction between the lock device (10) and the control server (20) is by means of a static magnetic field. However, other induction means such as light or sound signals are workable. For example, if the activating transmitting circuit (22) is implemented by a light signal emitting circuit, a light signal receiving circuit accordingly replaces the original first induction coil (121). Similarly, a voice signal emitting circuit and a voice signal receiving circuit can be respectively provided in the control server (20) and the lock device (10) to accomplish the same result.

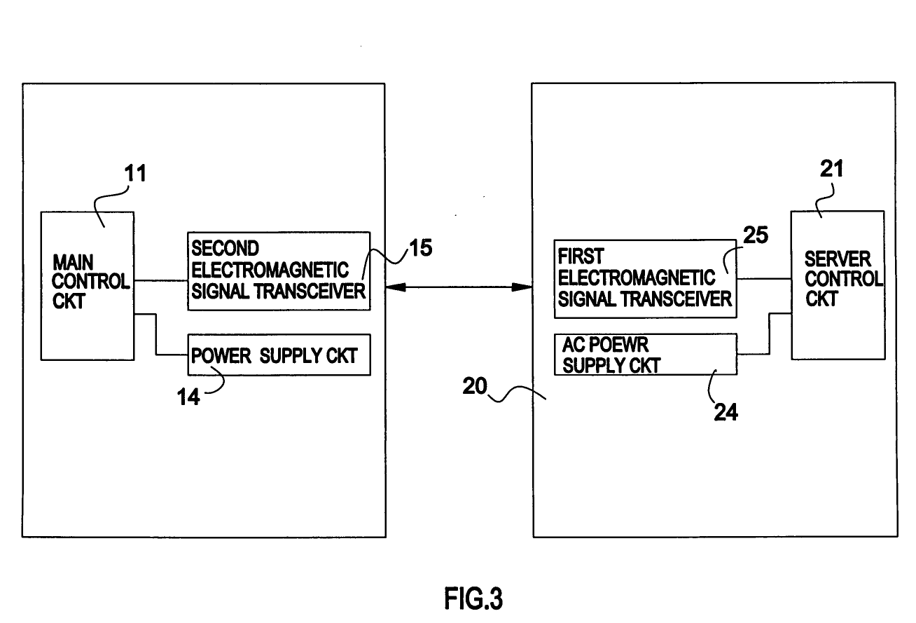

With reference to FIG. 3, the second embodiment of the present invention is similar to the first one of FIG. 1. The modification is that the activating signal receiving circuit (12) in the lock device (10) and the activating signal transmitting circuit (22) in the control server (20) are absent. Further, a second electromagnetic signal transceiver (15) is connected to the main control circuit (11) to operate in association with the first electromagnetic signal transceiver of the control server (20). The second electromagnetic signal transceiver (15) regularly emits a query signal to the control server (20) to detect whether the control server has received a remote signal from the user. If the remote signal is indeed received, the lock device (20) will automatically activate itself.

The present invention is not limited to the specially disclosed embodiments and variations, and modifications may be made without departing from the scope and spirit of the invention.

1. A combination electrical lock device comprising an electrical lock and a control server,
wherein the control server comprises:
a server control circuit, which controls all elements in the control server;
an activating signal transmitting circuit connected to the server control circuit, which outputs an activating signal to activate the electrical lock;
an AC power supply circuit connected to the server control circuit to supply an operating voltage for the control server; and
an electromagnetic signal transceiver connected to the server control circuit to receive a remote control signal;
wherein the electrical lock comprises:
a main control circuit, which controls all elements in the electrical lock device;
an activating signal receiving circuit connected to the main control circuit to receive the activating signal; and
a power supply circuit connected to the main control circuit to provide operating voltage for the electrical lock;
wherein when the electrical lock receives the activating signal from the control server, the power of the electrical lock is thus being activated.

2. The combination electrical lock device as claimed in claim 1, wherein the activating signal transmitting circuit of the control server has a magnetic field generating circuit having an input terminal connected to the server control circuit and having an output terminal connected to a first induction coil;
wherein the activating signal receiving circuit of the electrical lock has a signal amplifier having an input terminal connected to the main control circuit and having an output terminal connected to a second induction coil;
when the control server receives the remote signal, a static magnetic field is generated by the magnetic field generating circuit whereby when the second induction coil detects the static magnetic field, the electrical lock is then activated.

3. The combination electrical lock device as claimed in claim 1, wherein the activating signal transmitting circuit of the control server is a light signal transmitting circuit and the activating signal receiving circuit of the electrical lock is composed of a light signal receiving circuit and a signal amplifier.

4. The combination electrical lock device as claimed in claim 1, wherein the activating signal transmitting circuit of the control server is a sound signal transmitting circuit and the activating signal receiving circuit of the electrical lock is composed of a sound signal receiving circuit and a signal amplifier.

5. The combination electrical lock device as claimed in claim 1, wherein the power supply circuit of the electrical lock is provided by dry batteries.

6. The combination electrical lock device as claimed in claim 2, wherein the power supply circuit of the electrical lock is provided by dry batteries.

7. The combination electrical lock device as claimed in claim 3, wherein the power supply circuit of the electrical lock is provided by dry batteries.

8. The combination electrical lock device as claimed in claim 4, wherein the power supply circuit of the electrical lock is provided by dry batteries.

9. The combination electrical lock device as claimed in claim 1, wherein the power supply circuit of the electrical lock is provided by a solar energy circuit

10. The combination electrical lock device as claimed in claim 2, wherein the power supply circuit of the electrical lock is provided by a solar energy circuit.

11. The combination electrical lock device as claimed in claim 3, wherein the power supply circuit of the electrical lock is provided by a solar energy circuit.

12. The combination electrical lock device as claimed in claim 4, wherein the power supply circuit of the electrical lock is provided by a solar energy circuit.

13. A method for activating an electrical lock by a control server disposed near the electrical lock, comprising the acts of:
receiving a remote signal by the control server;
issuing an activating signal from the control server to the electrical lock; and
activating the electrical lock based on reception of the activating signal.

14. The method as claimed in claim 13, wherein the activating signal is in the form of a static magnetic field.

15. The method as claimed in claim 13, wherein the activating signal is in the form of a light signal.

16. The method as claimed in claim 13, wherein the activating signal is in the form of a sound signal.

17. A combination electrical lock device comprising an electrical lock and a control server,
wherein the control server comprises:
a server control circuit, which controls all elements in the control server;
a first electromagnetic signal transceiver connected to the server control circuit to receive a remote control signal; and
an AC power supply circuit connected to the server control circuit to supply an operating voltage for the control server;
wherein the electrical lock comprises:
a main control circuit, which controls all elements in the electrical lock device;
a first electromagnetic signal transceiver connected to the main control circuit to output a query signal to detect whether the control server has received the remote signal; and
a power supply circuit connected to the main control circuit to provide operating voltage for the electrical lock;
wherein when the control server receives the remote signal, the electrical lock is activated based on the detected result.
